(19) United States
(12) Patent Application Publication
(10) Pub. No.: US 2026/0254313 A1
(43) Pub. Date: Aug. 27, 2026

(54) MECHANICAL ENERGY ACCUMULATOR SYSTEM

(71) Applicant: Mario H. GOTTFRIED, Mexico D.F. (MX)

(72) Inventor: Mario H. GOTTFRIED, Mexico D.F. (MX)

(21) Appl. No.: 19/062,362

(22) Filed: Feb. 25, 2025

(51) Int. Cl. H02K 7/02; H02K 5/20; H02K 7/09

(52) U.S. Cl. CPC H02K 7/025; H02K 7/09; H02K 5/203

(57) ABSTRACT

A mechanical energy accumulator system has a housing, at least a pair of conical flywheels rotatable about a first axis within the housing, a shaft affixed to an interior of each of the conical flywheels so as to be rotatable in order to rotate the flywheel, a first magnetic bearing affixed to the housing so as to face an interior of the housing, and a first counter-magnetic bearing affixed to one end of the shaft. The first counter-magnetic bearing facing and adjacent to the first magnetic bearing such that the magnetic forces in the first magnetic bearing and in the first counter-magnetic bearing cause the first magnetic bearing and the first counter-magnetic bearing to be slightly spaced from each other in a friction-free relationship.

### CROSS-REFERENCE TO RELATED APPLICATIONS

Not applicable.

### FIELD OF THE INVENTION

The present invention relates to mechanical energy accumulator systems. More particularly, the present invention relates to energy storage system using arrangement of three counter-rotating pairs of electro-mechanical flywheels.

### BACKGROUND OF THE INVENTION

While flywheels are well known in the art, there has been very little application of flywheels for energy accumulation. Some flywheels have been used, in the past, in automobile engines to smooth out the pulses of energy provided by the exploding gases in the cylinders and to provide energy for the compression stroke of the pistons. However, flywheels have seldom been used for storage of kinetic energy.

It is highly desirable to utilize flywheel systems to store kinetic energy since they can be loaded and energy drawn many times. For example, a train equipped with a kinetic energy storing flywheel could conserve a significant portion of that energy which was lost upon stopping the train. Similarly, the energy wasted in stopping a moving vehicle could also be conserved and applied to accelerating the moving vehicle or supplying the moving vehicle with electrical power. Such a kinetic energy storage system could have vast applications in a variety of fields.

The gyroscopic effect of a single flywheel arrangement clearly prohibits its widespread use as a kinetic energy storer in vehicles. If a single flywheel system were used to store much of the kinetic energy lost during the stoppage of a train, then the gyroscopic effect of the spinning flywheel could cause a train to derail when it would go around a curve. Thus, it would be desirable to use a flywheel kinetic energy storing system without having to endure the undesirable characteristics of the gyroscopic effect.

One significant effort to achieve these benefits was found in U.S. Pat. No. 4,498,015, which issued on Feb. 5, 1985, to the present inventor. This device was a flywheel device for a moving vehicle that comprised a plurality of flywheel systems connected in such a manner as to minimize the gyroscopic effects of the flywheels. The flywheels were arranged such that they spin in axes that are ninety degrees from each other. In one embodiment of the invention, this was accomplished by attaching each flywheel to a separate shaft extending through opposing sides of a closed container. One shaft extends from the top to the bottom, another from side to side along the length of the enclosure, and the third from side to side along the width of the enclosure. Each of the shafts is freely rotatable within a ball bearing arrangement mounted in each side of the enclosure. The shafts are geared into one another such that the equally sized flywheels will spin at the same rate. This patent further proposed an alternative embodiment in which each of the flywheels was the rotor in an electric motor. The flywheel-rotor included integrated windings, magnets, and stator cores. Additionally, other techniques can be used such as hydraulic motor generators or pneumatic motor generators. The axes of these motors are arranged so as to be ninety degrees from each other. The electric motors were rigidly attached at a central area between them.

Unfortunately, this arrangement of flywheels was often difficult to configure so that all of the gyroscopic effects were eliminated. After a great deal of experimentation, it was found that the rotational movement of the flywheel, along each of the axes, still contributed gyroscopic effects. As such, a solution needed to be found as to how the minimize the gyroscopic effects along each axis.

In U.S. patent application Ser. No. 08/304,520, filed on Sep. 12, 1994, by the present inventor, described a system which minimizes gyroscopic effects from the rotational movement of the flywheels. In particular, this system is an energy storage apparatus that has a housing, a pair of flywheels rotatable about a first axis within the housing, a second pair of flywheels rotatable about a second axis within the housing, a third pair of flywheels rotatable about a third axis within the housing, and an energy input means connected to at least one of the flywheels for initiating and maintaining rotational movement of the flywheels. An output energy device serves to convert the rotation of the flywheels into potential energy. Each of the first pair of flywheels rotates in opposite directions. Each of the second pair of flywheels is rotatable in opposite directions. Finally, each of the third pair of flywheels is rotatable in opposite directions. Each of the axes of the flywheel pairs are perpendicular to each other. In this system, the energy input means was a motor-generator connected to each of the flywheels of the first, second and third pairs. Each of the flywheels has a shaft which extends centrally therefrom. The shaft is rotatable with the rotation of each of the flywheels. The motor-generator is connected to the shaft. In this system, the housing has a configuration of a sealed cube. Each of the flywheels is located adjacent a side of the cube. The housing has an interior which is maintained in a vacuum condition.

After experiments with that invention, it was found that these inventions strongly minimized the gyroscopic effects of the flywheels in the system. However, in actual use, there was the danger of injury caused by the flywheels spinning at a high speed. Under certain circumstances, in the event of an automobile accident or a collision when the flywheel disintegrates or bursts, pieces of the flywheel could come off of the spinning flywheel. The high speed at which the flywheel rotated created a dangerous condition whereby the flying pieces became the equivalent of flying shrapnel. As such, a need developed so as to create such an energy storage apparatus in which each of the flywheel components would automatically brake in the event of a collision.

It is further noted that with these prior systems, it is important to be able, under certain circumstances, to absorb the energy produced by such an apparatus. Adverse effects could be created by rigidly and fixedly mounting the housing of such an energy storage apparatus directly to a vehicle. The strong forces imparted by such a device could damage the structural integrity of the vehicle. Additionally, the flywheels housed in a cubic frame, when used in vehicles, are subject to possible disintegration or damage due to road shock and vibration. Such road shocks and vibrations must be absorbed in order to reduce any threat of damage to the flywheels, especially at higher vehicle and flywheel speeds. As such, a need developed so as to be able to reduce the shock and fatigue caused by the energy from road vibration and the shocks of bumps, holes and rocks as received by the vehicle during the normal driving movement of the vehicle.

U.S. Pat. No. 6,232,671, issued on May 15, 2001 to the present inventor, describes such a flywheel energy storage apparatus with a braking capability. Additionally, the patent addressed the problems of shock and fatigue, as well as the danger of shrapnel. The apparatus is designed for a vehicle that has a housing resiliently mounted in the vehicle. The apparatus has the pluralities of flywheels rotatable about separate axes within the housing. There is an energy input mechanism connected to one of the flywheels for initiating and maintaining rotational movement of the flywheels. An output mechanism converts the rotation of the flywheels into potential energy. Each of the flywheels of the first, second and third pairs are rotatable in opposite directions. Each of the axes are perpendicular to each other. A cradle is connected to the vehicle so as to receive the housing within the cradle. The flywheel system is designed to be safe, yet portable, as an electro-mechanical battery. The housing is in the shape of a cube. The housing has a braking capability, and is designed so as to reduce the amount of shrapnel released in the event of an accident. The integrity of the flywheel system was accomplished through the use of a stainless steel mesh formed around the housing. Additionally, a latex layer was formed beneath the stainless steel mesh, which added to both the strength and flexibility of the flywheel system.

U.S. Pat. No. 8,584,552, issued on Nov. 19, 2013 to the present inventor, teaches a high-speed conical flywheel system that has a motor, a drive shaft connected to the motor, an upper conical section affixed to the drive shaft, and a lower conical section affixed to the drive shaft opposite the upper conical section. The upper conical section and the lower conical section each have a plurality of layers, including a hollow core positioned adjacent the drive shaft and alternating layers of tempered rings and non-tempered rings arranged outwardly of the hollow core. The alternating layers of tempered rings and non-tempered rings are joined with an elastomeric adhesive. The plurality of layers further include a hollow cavity positioned outwardly of the alternating layers. A rim is positioned outwardly of the hollow cavity. The hollow cavity can be filled of the fluid.

U.S. Pat. No. 8,853,977, issued Oct. 7, 2014 to the present inventor, describes a mechanical energy accumulator suitable for being mounted in a vehicle. This mechanical energy accumulator has a spherical housing with three pairs of flywheel assemblies mounted therein. Each of the pairs of flywheel assemblies is rotatable in opposite directions about a respective axis. Each of the axes are perpendicular to one another. At least one permanent magnet motor is mounted within the flywheel assemblies. Each of the flywheels of the flywheel assemblies has a double conical flywheel base, a motor-generator suitable for driving the double conical flywheel base, and a flywheel lid covering the motor-generator. The mechanical energy accumulator may be mounted in a shell having an expansion member. The mechanical energy accumulator has a strong side and a weak side due to varying retention strength of windings therearound so as to create a controlled burst.

U.S. Pat. No. 8,759,992, issued on Jun. 24, 2014 to the present inventor, teaches a spherical mechanical energy accumulator system that is a housing, a first pair of flywheels rotatable about a first axis within the housing, a second pair of flywheels rotatable about a second axis within the housing, and third pair of flywheels rotatable about third axis in the housing. Each flywheel of the first pair of flywheels is rotatable in opposite directions. Each flywheel of the second pair of flywheels is rotatable in opposite directions. Each flywheel of the third pair of flywheels is also rotatable in opposite directions. The first, second and third axes are orthogonal to each other. An energy input is cooperative with at least one of the flywheels for supplying electrical energy so as to rotate the flywheel. An energy output is also provided for converting the rotation of the flywheels into potential energy. Each of the flywheels has a double conical shape.

U.S. Pat. No. 11,791,689, issued Oct. 17, 2023 to the present inventor, shows a mechanical energy accumulator system that is a housing with a first pair of flywheels, a second pair of flywheels and a third pair of flywheels. Each of the flywheels is formed of a ceramic material. A stator is positioned in an interior of each of the flywheels. A pipe shaft is positioned interior of the stator. The pipe shaft has a plurality of magnets therein. A circular pipe is embedded within each of the flywheels. The circular pipe has a fluid contained therein.

Importantly, U.S. Pat. No. 8,759,992, issued on Jun. 24, 2014 to the present inventor, described a previous version of the present invention. This previous version is illustrated as “Prior Art” in FIGS. 1-3 herein. Referring to FIG. 1, there is shown the mechanical energy accumulator 10 of the prior art. The mechanical energy accumulator 10 has a generally spherical-shaped housing 12. First flywheel lid 14, second flywheel lid 16, and third flywheel lid 18 are affixed to the exterior of the housing 12. Each of these flywheel lids covers flywheels that are located internally of the spherical housing 12. These flywheels are shown in more detail in FIG. 2. The housing 12 has a configuration of a sealed sphere or ball. Three other flywheel lids are affixed to the spherical housing 12, but are not shown in FIG. 1. Each of the lids 18 is designed to be tight fitting, and secured with a winding of cable or steel, further using glue or latex rubber for an absolute failsafe sealing.

Each of the flywheel lids 14, 16, and 18 are shown having cooling lines 20 in communication with an interior thereof. The water cooling lines 20 provide for the circulation of water around the system so as to appropriately cool the flywheels as they rotate on the interior of housing 12. Brackets 22 extend outwardly from the spherical housing 12 and are used to connect the mechanical energy accumulator 10 to the interior of the vehicle.

The interior of the housing 12 is in a vacuum condition so as to minimize any friction through the rotation of the flywheels within the interior of the housing 12. This vacuum condition can be created by the use of a commercial vacuum pump acting on the interior of the housing 12. A vacuum valve 44 is shown exterior of the spherical housing 12 and may be connected to such a vacuum pump. A vacuum line also extends into the interior of the housing 12 so as to appropriately maintain cooling to the bearings, magnets and motors in a vacuum condition.

The housing 12, along with its associated components, is positioned within the interior of a vehicle. The mechanical energy accumulator 10 is contemplated for use in conjunction with a bus. However, all vehicles or vessels can be included, including spacecraft. The mechanical energy accumulator 10 would work best in space due to the vacuum condition of space itself.

Referring to FIG. 2 there is shown an exploded view of the mechanical energy accumulator 10. The three pairs of flywheels are shown in a ball configuration. There is shown the first flywheel 24, a second flywheel 26 and a third flywheel 28. Below the flywheels is shown the spherical housing 12. The spherical shape of the housing 12 allows for a more efficient use of the volume of the mechanical energy accumulator 10. With the flywheels formed in a double-conical configuration, most of the space within the housing 12 is utilized. Each of the flywheels has a lower cone section which converges toward the center of the housing 12, and an upper cone section which follows the curved wall of the housing 12. An inner support structure 40 maintains the structure of the housing 12 and the housing wall 46. A convergence support 42 is shown in the center of the spherical housing 12. The convergence support 42 is at a point where the ends of the flywheels meet in the center of the spherical housing 12. The convergence support defines the axes about which the pairs of flywheels rotate.

FIG. 2 also shows the third flywheel cap 18. The structure of the third flywheel cap 18 is essentially identical to the other flywheel caps shown in FIG. 1. There are six flywheel caps in total which cover each of the flywheels and are affixed flush with the housing wall 46 of the spherical housing 12. In the center of the flywheel cap 18, there is shown the motor 34 of the mechanical energy accumulator 10. The stator windings 38 of the motor 34 are attached to the flywheel cap 18. Each of the flywheel caps may have identical motors 34 and stator windings 38. The stator windings 38 of the motor 34 interact with each of the rotors 36 found on each of the flywheels. The rotors 36 are situated within the stator windings 38 of the motor 34. The motor 34 can be used to initiate the rotation of each of the flywheels and also to capture energy from the rotating flywheels.

In FIG. 2, it can be seen that each of the flywheels 24, 26 and 28 rotates about axes which are perpendicular to each other. In the concept of the present invention, flywheels can also face the other sides of the housing 12. In other words, another flywheel will face the back side of housing 12 opposite the flywheel 24. A flywheel 30 will face the side opposite flywheel 26. Another flywheel 32 will face the housing 12 opposite flywheel 28. The flywheel 24 and the opposing flywheel on the other side of the housing 12 will rotate about the same axis but will rotate in opposite directions. The flywheel 26 and the flywheel 30 on the opposing side of housing 12 will rotate about the same axis but will rotate in opposite directions. Finally, the flywheel 28 and the flywheel 32 on the opposite side of the housing 12 will rotate about the same axis but in opposite directions. These flywheels, opposite each other on the same axis, turn in the opposite direction so as to achieve the gyro-neutral characteristics obtained in a three-dimensional configuration. Counter-rotating flywheels are known to neutralize certain gyroscopic effects on the same plane. The mechanical energy accumulator 10 serves to make gyro-neutral all movement aspects of the entire assembly. The gyro-effects are transferred to the enclosure, to the bearings, and to the shafts of each plane of flywheel axis. As a result, a vehicle connected to the mechanical energy accumulator 10 will be free of gyro-limitations.

Although not shown in FIG. 1 or 2, the mechanical energy accumulator 10 may be wrapped with a cable or wire winding in order adequately secure the caps. This adds strength to the system and also prevents shrapnel from separating from the mechanical energy accumulator 10 in the event of a collision or accident. The mechanical energy accumulator 10 has an ability to flex in the event of a collision. In particular, the enclosure is appropriately flexible so that, in the event of a collision, adjacent flywheels will contact each other so as to create a braking effect by the contact of flywheel against flywheel (indicating contact at its smallest diameter).

This structure provides the maximum neutralization of the gyroscopic phenomenon. The sphere form of the three-dimensional flywheel assembly can serve as an energy storage apparatus. It is also possible that various forms could also be used so as to achieve the same neutralization of the gyroscopic phenomenon. The spinning of the flywheels in opposite directions on the same axis serves to neutralize all gyroscopic effects on that axis. The speed of each flywheel should be in synchronism and the weight of each flywheel should be the same. Since the gyroscopic effect is neutralized per plane-axis, this three-dimensional arrangement adds gyroscopic neutralization to the entire sphere. As such, all possible movements of a moving vehicle or vessel are covered.

The entire unit of this patent results in a sphere-shaped housing having six flywheels. One or more spheres can be interconnected electrically so as to operate as an electro-mechanical battery. Such a battery can be charged and recharged in an unlimited fashion. This electro-mechanical battery permits regenerative braking to occur during the operation of the motor vehicle.

The flywheels can be made of rings which are of different materials and densities. As such, certain of the rings can act as springs. The rings can be formed in layers of “half-moon” shapes so that in an impact or blow of low intensity, the flywheels will have some “give” in a spring type of absorption. Under normal centrifugal force, the rings will be rigid and remain in place. Additionally, the flywheel can be hollow or be mercury-filled, or filled with some other liquid. The liquid will allow absorption to an impact force or a strike. If the flywheel does disintegrate, the liquid will allow for a containment of the pieces of the flywheel. A liquid-filled or hollow flywheel will also offer inherent balancing and weight advantages for higher energy storage at given speeds.

Referring to FIGS. 3 and 3A, there is shown a schematic view of an alternative embodiment FIG. 1. The alternative embodiment is a flywheel system 50 utilizing a pipe 52 and a plurality of flywheel units 54. The plurality of the flywheel units 54 are positioned within a length of pipe 52. The bearing mounts 56 of the flywheel units 54 are exposed through openings 58 along the length of pipe 52. Aside from the bearing mounts 56, the remainder of the components of the flywheel units 54 are contained within the length of pipe 52. Similar to the configuration of the flywheels described hereinabove, the flywheel units 54 include a first pair of flywheels rotatable about a first axis within the pipe, a second pair of flywheels rotatable about a second axis within the pipe, and a third pair of flywheels rotatable about a third axis within the pipe. The first, second and third axes are orthogonal to each other. Alternatively, two pairs of flywheels may be used. Each of the flywheels may have a brushless DC motor thereon. The brushless DC motor may have permanent magnet rotors. The use of the pipe 52 minimizes danger associated with the high speed of the flywheels. Further, the use of the pipe allows for a vacuum to be sustained therein.

FIG. 4 is an exploded view showing the mechanical energy accumulator system 60 of prior art of U.S. Pat. No. 11,791,689 of the present inventor. This mechanical energy accumulator system includes a housing 62 having a flywheel 64 received within an opening 66 of housing 62. Flywheel 64 is of a ceramic construction and has an interior area 68. Flywheel 64 has a generally conical or double conical configuration. A rotor shaft 70 is supported by magnetic bearings 72 and 74 at opposite ends thereof. Magnetic bearings 72 and 74 are doughnut-shaped magnetic bearings. A stator core 76 is positioned so as to be received within the interior area 68 of flywheel 64 and be positioned over rotor shaft 70. It can be seen that the magnets 78 are positioned so as to be received within slots formed on the rotor shaft 70. Magnets 78 will interact with the windings in the stator core 76 for the transfer of energy.

The housing 62 will, in particular, have flywheel 64 positioned in opening 66. There will be a second pair of flywheels (such as shown in FIGS. 2 and 3) positioned within the housing 62 below cover 80. Another flywheel will be positioned in housing 62 built under cover 82. The construction of the housing 62 will have the first pair of flywheels (such as shown in FIGS. 2 and 3), the second pair of flywheels and the third pair of flywheels (such as shown in FIGS. 2 and 3) configured in the manner shown herein in association with FIGS. 1-3. The first pair of flywheels will rotate within the housing 62 in opposite directions. The second pair of flywheels will rotate within the housing 62 in opposite directions. The third pair of flywheels within the housing 62 will rotate in opposite directions. The first pair of flywheels will rotate about a first axis. The second pair of flywheels will rotate about a second axis. The third pair of flywheels will rotate about a third axis. These axes will be perpendicular or transverse to each other within the housing 62. The interior 66 of the housing 62 will be maintained in a vacuum condition.

In FIG. 4, it can be seen that there is a jewel bearing 84 extending in the housing 62. A point bearing 86 will be received by the jewel bearing 64 in a “pin-and-jewel” arrangement. Another jewel bearing 88 will receive point bearing 90 also in another pin-and-jewel type of configuration. A fine adjustment assembly 92 will act on the point bearing 90 and the jewel bearing 88. The fine adjustment assembly 92 will extend to an adjustment insert 94. A frame lid 96 will cover the assembly within the interior of the housing 62. A flat washer 98 and a fine adjustment nut 100 complete the assembly. This arrangement of elements will extend for each of the flywheels within the interior of the housing 62.

FIG. 5 shows the configuration of a flywheel assembly 102 located within the interior of housing 62. Initially, it can be seen that the flywheel assembly 102 has ceramic masses 104 and 106. A pipe 108 will be embedded within a channel 110 formed in the ceramic masses 104 and 106. In particular, in the present invention, the flywheel assembly 102 will have a first half body and a second half body formed of a ceramic material. This first half body and the second half body can be joined to each other by mechanical means, by adhesives, by molding, or by other techniques. The channel 110 is formed at least one of the first half body in the second half body. The pipe will be installed within channel 110. Pipe 108 has a circular configuration that is generally concentric with the outer diameter 112 of the ceramic mass 104. This pipe 108 will be generally positioned midway between the outer diameter 112 and an inner diameter 114 of the ceramic mass 106. The pipe 108 will have a fluid 115 therein. In the preferred embodiment of the present invention, this fluid 115 will fill approximately one-half of the volume of the pipe 108.

The motor stator 116 is located within the interior area of the ceramic mass 106. It should be noted that the ceramic masses 104 and 106 are integrally formed together in a molding process. The ceramic masses are simply separately identified as being on opposite sides of the pipe 108. The motor stator 116 is bolted to the ceramic mass by stator bolts 118. The motor stator can act as an AC/DC universal motor.

The pipe shaft 120 is positioned interior of the motor stator 116. Pipe shaft 120 acts as a rotor. Pipe shaft 120 includes slots 122 therein. Slots 122 serve to receive the magnets 124 therein (as shown in FIG. 6 hereinafter). In particular, there are four slots 122 for receiving four magnets. These slots are closed on the outside and open at an interior so as to fit tight. The pin-and-jewel bearing 126 will act on the inner diameter of the rotor 120.

FIG. 6 shows a detailed view of the motor stator 106 and the rotor 120. It can be seen that the motor stator 106 has a plurality of channels 130 that are formed so as to face an inner diameter 132 of the motor stator 106. Channels 130 are adapted to receive windings therein. The pipe shaft 120 includes slots 122 that open to the inner diameter of the pipe shaft 120. Magnets 124 are received in the slots 122, respectively. Each of the magnets 124 has a magnetic face generally adjacent to the outer diameter 134 of the pipe shaft 120. As such, the magnetic face of the magnets 124 will be adjacent to the windings supported by channels 130 of motor stator 106. It can be seen that there are a pair of N magnets 124 that are in diametrically opposed locations on the pipe shaft 120. There are a pair of S magnets that are in diametrically opposed locations on the pipe shaft 120. Each of the magnets 124 is spaced by 90° from an adjacent magnet.

There have been a variety of other mechanical energy accumulator systems that have been developed over the years other than those of the present inventor. In particular, U.S. Pat. No. 8,622,860, issued on Jan. 7, 2014 to Versteyahe et al., describes a method and apparatus for transferring power between a flywheel and a vehicle. The vehicle driveline includes a power source, a clutch drivingly engaged with the power source, a transmission drivingly engaged with the clutch, a power transmission device drivingly engaged with one of the power source, the clutch in the transmission, a controller in communication with the power transmission device, and a flywheel drivingly engaged with the power transmission device. The power transmission device facilitates a transfer of energy from the flywheel to one of the clutch and the transmission.

U.S. Pat. No. 9,358,865, issued on Jun. 7, 2016 to R. C. Sherry, teaches a flywheel-operated vehicle. The engine drives the flywheel using a differential axle, while also driving a pair of other differentials each of which is connected to a respective drive wheel. The rotation of half shafts of the pair of differentials are controlled to determine the extent of power transferred from the flywheel to the drive wheels during acceleration and determines the power transferred from the drive wheels to the flywheel during deceleration of the vehicle. The flywheel can be tilted around a roll axis of the vehicle to counteract roll tendencies of the vehicle when turning a sharp corner.

U.S. Pat. No. 10,047,823, issued on Aug. 14, 2018 to Rivas et al., shows an energy storage device having a housing, at least one flywheel disposed in the housing, and at least one stabilizing element disposed in the housing and configured to stabilize the flywheel. There can be at least one cooling element for cooling a region interior of the housing to a preset temperature. The stabilizing element comprises a magnet. The stabilizing element can be oriented at a position offset from a horizontal axis. The stabilizing element is oriented at a position offset from the vertical axis.

U.S. Pat. No. 10,050,491, issued on Aug. 14, 2018 to Groves et al., describes a flywheel formed of a composite material having fibers that are oriented substantially in a circumferential direction around the flywheel and embedded in a matrix material. The flywheel has an inner surface, an outer surface, and a thickness therebetween that defines an axis of rotation. A plurality of load masses are distributed circumferentially on the inner surface at a longitudinal segment along the axis. A rotation of the flywheel around the axis with a rotational velocity generating hoop stress in the fibers in the circumferential direction and through-thickness stress is generated in the matrix material in a radial direction.

U.S. Patent Application Publication No. 2004/0026927, published on Feb. 12, 2014 to Stevenson et al., describes a flywheel-based regenerative energy management system. The system has a flywheel assembly within integrated motor-generator which is coupled to a drivetrain motor-generator. The coupling between the flywheel assembly in the drivetrain motor-generator includes a system controller having integrated voltage control and inverters. The system controller has integrated inverters and voltage control that determine the direction and flow of current between the flywheel assembly and the drivetrain motor-generator.

U.S. Patent Application Publication No. 2005/0248321, published on Nov. 10, 2005 to Liu et al., provides a flywheel energy storage system including a driving wheel rotatable relative to a first axis, an electric motor for driving the driving wheel, an electric generator, a driven wheel adapted to drive the electric generator, a flywheel rotatable relative to a second axis parallel to the first axis, a clutch assembly for disengagement or engagement of the flywheel and the driven wheel, and a transmission gear train assembly engagingly interposed between the flywheel and the driving wheel and adapted for conveying kinetic energy from the driving wheel to the flywheel.

U.S. Patent Application Publication No. 2010/0206126, published on Aug. 19, 2010 to Spears et al., provides an advanced flywheel hub for use in a flywheel rotor assembly. The hub includes a shaft-engaging portion and a rim-engaging portion that is configured for maintaining engagement with the shaft and the rim during operational rotation of the flywheel rotor assembly. The hub exhibits a bending mode and includes a first layer having axial fibers for stiffening the hub with respect to the bending mode. The hub can further include a stiffening arrangement for increasing the radial stiffness of the shaft-engaging portion.

U.S. Patent Application Publication No. 2012/0234981, published on Sep. 20, 2012 to Nagabhushan et al., describes a split flywheel assembly with attitude jitter minimization. The split flywheel assembly includes a plurality of independent concentric flywheels axially aligned and in operable engagement with one another such that each flywheel is configured to be independently controlled in order to manipulate the phase difference therebetween.

U.S. Patent Application Publication No. 2015/0211599, published in Jul. 30, 2015 to T. Baumer, this discloses a flywheel energy store having a rotor having such a hub, and a flywheel energy store having the rotor. The hub is produced as one piece from a carbon fiber-reinforced plastic laminate having a network of carbon fibers that cross at a weaving angle and having a matrix material.

It is an object of the present invention to provide a mechanical energy accumulator system which reduces and minimizes gyroscopic effects.

It is another object of the present invention to provide a mechanical energy accumulator system that has a very long life.

It is another object of the present invention to provide a mechanical energy accumulator system that allows for the production of electrical energy.

It is another object of the present invention to provide a mechanical energy accumulator system which minimizes interior friction.

It is a further object of the present invention to provide a mechanical energy accumulator system which reduces the potential for damage and destruction in the event of an accident or in the event of a damaging occurrence.

It is another object of the present invention to provide a mechanical energy accumulator system which can operate with other flywheel systems, other batteries, and other engines.

It is a further object to the present invention to provide a mechanical energy accumulator system that has an extremely strong flywheels.

It is a further object of the present invention to provide a mechanical energy accumulator system that restrains a mass expansion of the rotor.

It is another object of the present invention to provide a mechanical energy accumulator system which avoids surface particle fly-off.

It is another object of the present invention to provide a mechanical energy accumulator system that attenuates micro-vibrations.

It is a further object of the present invention to provide a mechanical energy accumulator system that self-corrects for imbalances.

These and other objects and advantages of the present invention will become apparent from a reading of the attached specification and appended claims.

### SUMMARY OF THE INVENTION

The present invention is a mechanical energy accumulator system having a housing, at least a pair of conical flywheels rotatable about a first axis within the housing, a shaft affixed to the interior of each of the conical flywheels, a first magnetic bearing affixed to the housing so as to face an interior of the housing, and a first counter-magnetic bearing affixed to one end of the shaft. The shaft is rotatable during the rotation of the flywheel. The first counter-magnetic bearing faces and is adjacent to the first magnetic bearing such that the magnetic forces in the first magnetic bearing and in the first counter-magnetic bearing cause the first magnetic bearing and the first counter-magnetic bearing to be slightly spaced from each other.

A second magnetic bearing is positioned generally centrally of an interior of the housing and a second counter-magnetic bearing is affixed to an opposite end of the shaft. The second magnetic bearing and the second counter-magnetic bearing face each other such that magnetic forces in the first magnetic bearing and in the second counter-magnetic bearing cause the first magnetic bearing and the second counter-magnetic bearing to be slightly spaced from each other. The first magnetic bearing has a generally conical shape. The first counter-magnetic bearing also has a matching conical indentation configured to overlie the generally conical shape of the first magnetic bearing. The second magnetic bearing also has a conical shape. The second counter-magnetic bearing has a conical indentation overlying the generally conical shape of the second magnetic bearing. The first magnetic bearing is, in the preferred embodiment, a double cone magnet. A portion of the double cone magnet extends into the interior of the housing. The second magnetic bearing is also a double cone magnet.

A motor/generator is connected to each of the conical flywheels. The motor/generator is adapted to store or to produce energy in relation to a rotation of the flywheel. A cooling fluid line extends into the housing so as to pass a cooling fluid to the motor/generator. The motor/generator has at least one of a stator and a winding affixed to the flywheel and another of the stator and the winding affixed to the housing. The motor/generator has a power line extending outwardly of the housing and is adapted to pass electrical energy to a location remote of the housing.

Each of the conical flywheels has a plurality of sections that are affixed together by a glue. Each of the conical flywheels, in a preferred embodiment, has a hoop affixed thereto. It contains a liquid. The hoop has an interior volume in which the interior volume of the hoop is approximately one-half filled with the liquid. Each of the flywheels is formed of a plurality of sections. The hoop is positioned between adjacent sections of the plurality of sections. Each flywheel of the plurality of flywheels has an outer covering. This outer covering can be of a composite material of a KEVLAR™ material. The generally conical shape of the first magnetic bearing and the conical indentation of the second counter-magnetic bearing can have a stepped configuration. A jewel is interposed between a tip of the generally conical shape of the first magnetic bearing and an interior of the conical indentation of the second counter-magnetic bearing.

The flywheels of the present invention include six flywheels arranged within the housing. The six flywheels include a first pair of flywheels arranged so as to be rotatable in opposite directions about a first axis, a second pair of flywheels arranged so as to be rotatable in opposite directions about a second axis, and third pair of flywheels arranged so as to be rotatable in opposite directions about third axis. The first axis, the second axis and the third axis are orthogonal to each other. The housing is of a generally spherical configuration.

The present invention utilizes kinetic energy to story energy. This allows for the loading of electrical vehicles by accelerating the various flywheels in any location where electrical power is required. It can even charge up remote customers and to backup utility power as a reserve when the electrical the vehicle loading is massive. The present invention increases energy storage performance. As masses increase, an increased speed is achieved as kinetic phenomena regarding harmonics and bearings is achieved. The present invention utilizes six large and strong flywheels. The mechanical energy accumulator system of the present invention is stationary in the form of a large sphere with a vacuum interior. This sphere can operate for over forty years. Once the flywheel apparatus begins to operate, all of the energy that is obtained is free. As such, it can provoke more people to use electrical vehicles, cook with electricity, and to heat with electricity. The present invention can be a preferred energizer and reverses the need of combustion by using electricity as fuel.

The present invention include six 150 kilogram flywheels that can rotate up to 50,000 rpms. Each of the flywheels can have a twenty inch outer diameter the flywheels are arranged in three orthogonal axes. Each of the flywheels can be cast with maraging steel. A composite shell covers all of the flywheels. The assembly is sized to store approximately 20 kW. As such, it is a very substantial battery. The present invention, when compared to the prior art, has better weight distribution, allows for a safer speed, and becomes a proper bank for electricity.

The present invention has no-touch magnetic conical bearings for the high-speed rotors. This achieves very low friction and very low loss because of the magnetic repulsion bearings for the flywheels. The conical bearings for heavy rotors are very strong. The heavy flywheels will need stronger magnetic repulsion bearings. The present invention provides an attenuation response for vibrations.

The present invention employs improved flywheels so as to achieve higher speeds and add more weight for added energy accumulation, storage, and production. The drive includes six robust D. C. brushless, in sync motor/generators for both AC and DC electrical power. It is run by a smart control. Each single flywheel can accelerate to higher speeds using magnetic repulsion bearings. It can also achieve harmonic attenuation and precision balance. The limits of the strength and characteristics of materials is in direct proportion to the limits of performance during fast rotation limits of expansion and imbalance. Banks of spheres containing the flywheel system of the present invention can provide emergency power into large kinetic electro-mechanical energy banks. The operation is very basic. There is a controlled frequency that drive six motors per set. Each set uses six heavy, very fast and strong flywheels. The motors are two-pole, thirty horsepower motors that can rotate up to 50,000 rpms. The energy used to speed up mass will store this energy under the natural laws of kinetics and momentum until it is all used. All six flywheels should be free of friction. This is because any rub, touch, push, pull or lean will require greater effort to accelerate. As such, power will be wasted. The present invention employs repulsion magnets in the form of cones that fit inside a counter cone. As such, the dual repulsion magnets will never touch.

The magnets can be made from rare earth metals. This is the only limit on increased weight. The present invention increases energy storage capacity by using the six large, fast and heavy flywheels that weigh up to 150 kg each. As such, the present invention will have a weight of approximately 900 kg in a ball-shaped frame of approximately 100 kg. The housing or frame is reinforced into a cube of structural steel. As such, the present invention provides an approximately 1200 kg package that is capable of storing approximately 20 kWh of power. This is greater than the energy needed to load up the electric vehicle.

An electronic control of the known art will open a source of energy necessary to accelerate the flywheels. The large strong motor accelerates faster so as to speed up the effective the capacity quickly. The captured energy can be used to be applied elsewhere. As such, it becomes a very effective storage device.

Each rotor generates a gyroscopic effect. However, this gyroscopic effect becomes a neutral gyroscopic effect on the entire device due to the counter rotation on opposite sides of a three-dimensional mounting of the six flywheels and motors. Once in operation, with the six flywheels in sync, the present invention becomes gyro-neutral. This neutral effect avoids the energy form that pulls or drags in order to follow the direction of rotation. The present invention could also be used in association with steering by turning the flywheels in the same direction.

Even though the rotors are balanced to precision, another energy form is present. This energy form is “harmonics”. The harmonics can be attenuated by several methods. The present invention utilizes liquid in a hose hoop. The hose hoop is half-filled with a liquid and placed interior of the rotor. The liquid is free to react to vibrations and will press on the outside, due to centrifugal force. Because the harmonics are a vibration, the liquid will respond and vibrate as well so as to soften most or all of the harmonic effects. Another method for harmonic dampening is a soft glue or a soft membrane between the flywheel sections. This can soften the vibrations, including micro imbalances.

The present invention can be made in a factory with mass production techniques and robotics. The final assembly is fast, easy-to-use, and has high precision. The finished units can be stored for shipment in volume.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a perspective view of the exterior of a prior art mechanical energy accumulator system.

FIG. 2 is an exploded view of the prior art mechanical energy accumulator system of FIG. 1.

FIGS. 3 and 3A are side and cross-sectional views, respectively, of an alternative embodiment of the prior art mechanical energy accumulator system of FIG. 1.

FIG. 4 is an exploded perspective view of the mechanical energy accumulator system of the prior art.

FIG. 5 is a cross-sectional view taken across lines 5-5 of FIG. 4 showing one of the flywheels of the mechanical energy accumulator system of the prior art.

FIG. 6 is a cross-sectional view taken across lines 5-5 of FIG. 4 showing the relationship between the stator and the pipe shaft in the mechanical energy accumulator system of the prior art.

FIG. 7 is a cross-sectional view of the mechanical energy accumulator system of a simplified form of the present invention.

FIG. 8 is a cross-sectional view of the mechanical-the end of the mechanical energy accumulator system of the preferred embodiment of the present invention.

FIG. 9 is an exploded view of the configuration securing the flywheel within the mechanical energy accumulator system of the present invention.

FIG. 10 is a cross-sectional view of an alternative embodiment of the simplified form of the mechanical energy accumulator system of the present invention.

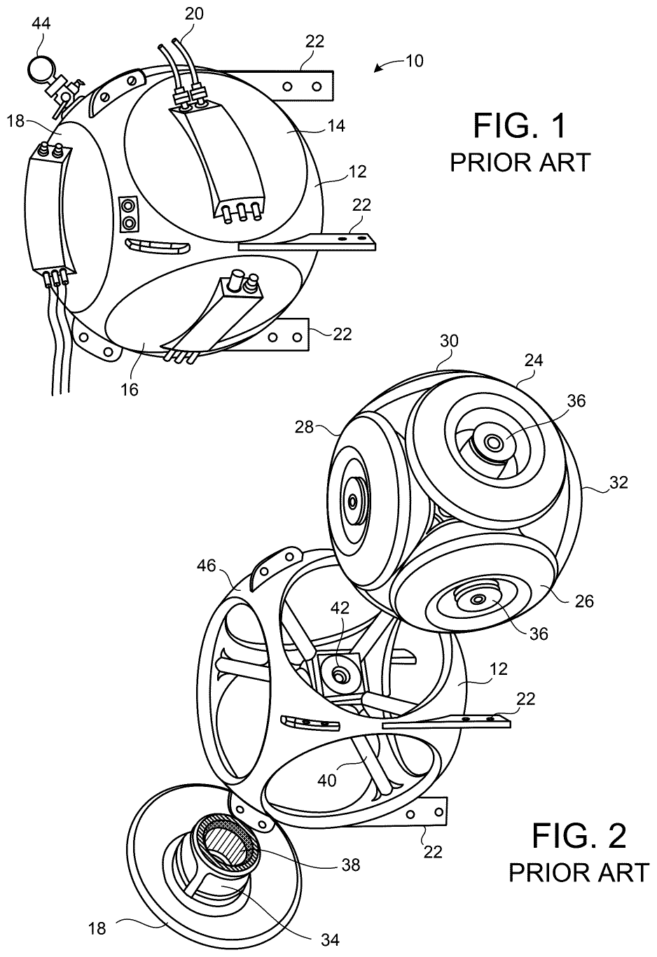

### DETAILED DESCRIPTION OF THE INVENTION

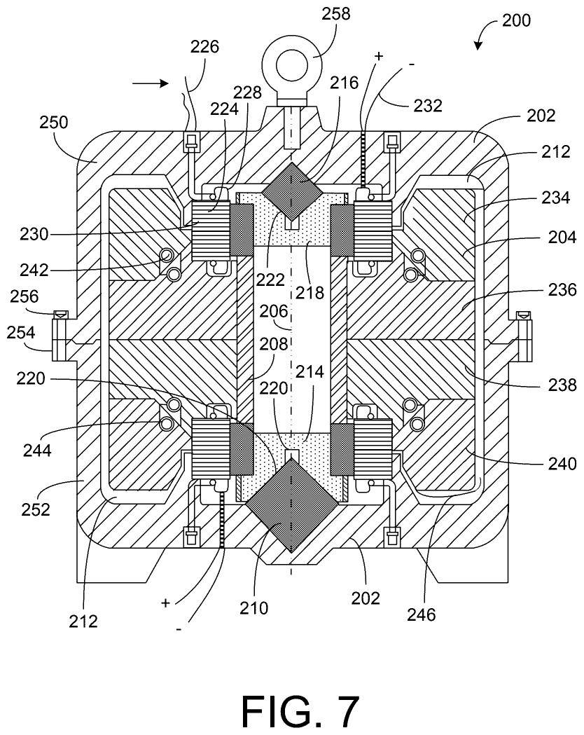

Referring to FIG. 7, there is shown the mechanical energy accumulator system 200 in accordance with the teachings of a simplified embodiment of the present invention. The mechanical energy accumulator system 200 includes a housing 202. A conical flywheel 204 is rotatable about a first axis 206 within the housing 202. A shaft 208 is affixed to an interior of the flywheel 204 such that the shaft 208 rotates with the rotation of the flywheel 204. A first magnetic bearing 210 is affixed to the housing 202 so as to face an interior 212 of the housing 202. A first counter-magnetic bearing 214 is affixed to one end of the shaft 208. This first counter-magnetic bearing 214 faces the first magnetic bearing 210 and is adjacent to the first magnetic bearing 210 such that the magnetic forces in the first magnetic bearing 210 and in the first counter-magnetic bearing 214 cause the first magnetic bearing 210 and the first counter-magnetic bearing 214 to be slightly spaced from each other in friction-free relationship.

A second magnetic bearing 216 is affixed to the housing 202 and faces and the interior 212 of the housing 202. A second counter-magnetic bearing 218 is affixed to an opposite end of the shaft 208. The second magnetic bearing 216 and the second counter-magnetic bearing 218 face each other such that the magnetic forces in the second magnetic bearing 216 and the second counter-magnetic bearing 218 cause the second magnetic bearing 216 and the second counter-magnetic bearing 218 to be slightly spaced from each other in friction-free relationship. As such, the shaft 208 and the conical flywheel 204 are supported within the housing 202 in a friction-free relationship with the magnetic bearings 210 and 216. No part of the flywheel 204 touches other surfaces within the interior 212 of the housing 202.

In FIG. 7, it can be seen that the first magnetic flywheel 210 has a generally conical shape. The second counter-magnetic bearing 214 has a conical indentation 220 configured overlie the generally conical shape of the first magnetic bearing 210. Similarly, the second magnetic bearing 216 has a generally conical shape. The second counter-magnetic bearing 218 has a conical indentation 222 that overlies the conical shape of the second magnetic bearing 216. In particular, the first magnetic bearing 210 is a double cone magnet. A portion of this double cone magnet extends into the interior 212 of the housing 202. Similarly, the second magnetic bearing 216 is also a double cone magnet. At least a portion of this double cone magnet of the second magnetic bearing 260 also extends into the interior 212 of the housing 202.

A motor/generator 224 is interactive with the conical flywheel 204. The motor/generator 224 is adapted to store or produce energy in relation to a rotation of the flywheel 204. A cooling fluid line 226 extends into the housing 202 so as to pass a cooling fluid to the motor/generator 224. The motor/generator 224 includes a stator 228 and a winding 230. One of the stator 228 and the winding 230 is affixed to the flywheel 204. Another of the stator 228 and the winding 230 is affixed to the housing 202. The motor/generator 224 has a power line 232 extending outwardly of the housing. Power line 232 is adapted to pass electrical energy to a location remote of the housing 202.

The conical flywheel 204 has a plurality of sections 234, 236, 238 and 240. The sections 234, 236, 238 and 240 are affixed to each other by a glue or other adhesives. A hoop or hoops 242 is affixed in an area between sections 234 and 236. Hoop 242 contains a liquid. This liquid fills one-half of the interior volume of the hoop or hoops 242. Similarly, another hoop or hoops 244 are positioned between the sections 238 and 240 of the flywheel 204. These hoops 244 are half-filled with a fluid or a liquid. The half-filling of the hoop or hoops 242 and 244 serves to attenuate vibrations within the mechanical energy accumulator system 200.

FIG. 7 shows that the flywheel 204 has an outer covering 246. This outer covering 246 should cover the entire exterior of the flywheel 204 so as to further enhance the structural integrity of the flywheel 204. The outer covering 246 can be formed of a composite or of a KEVLAR™ material.

FIG. 7 shows that there is a jewel 248 that is positioned in a location at a tip of the first magnetic bearing 210 and within the interior of the first counter-magnetic bearing 214. Similarly, another jewel is positioned at the tip of the second magnetic bearing 216 and in an interior of the second counter-magnetic bearing 218. This jewel is intended to assure that a virtually friction-free relationship between the magnetic bearing and the counter-magnetic bearing occurs in the event of contact between the surfaces.

FIG. 7 further shows that the housing 202 is made up of a pair of clamshell sections 250 and 252 that are joined together at flanges 254 by a bolt 256. As such, all of the elements within the interior of the housing 202 are secured together. A mounting clevis 258 is provided at the top of the housing 202 so as to allow for the transport of the mechanical energy accumulator system 200 of this simplified form of the present invention.

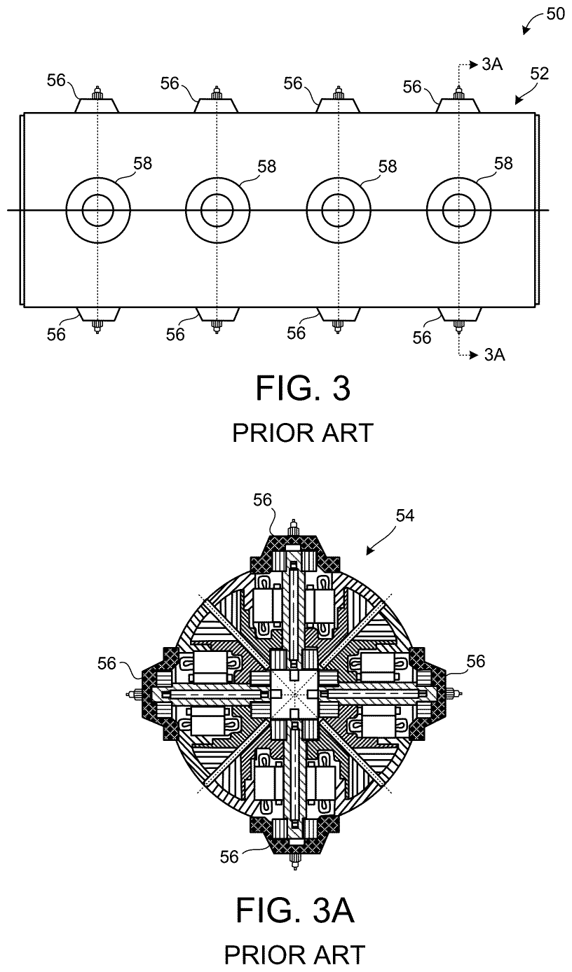

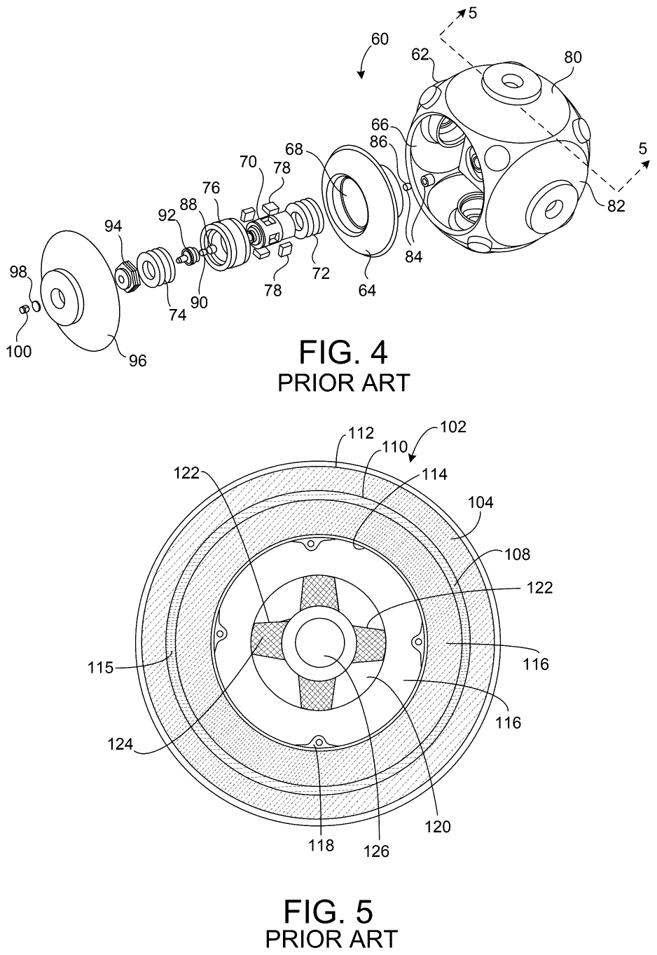

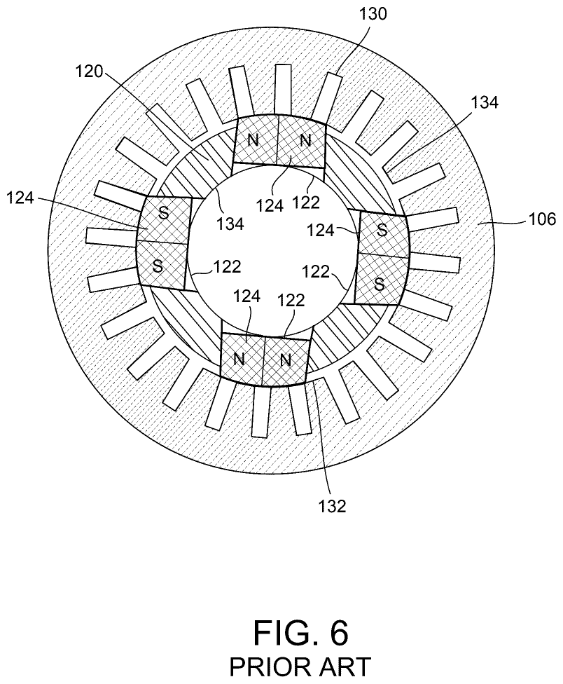

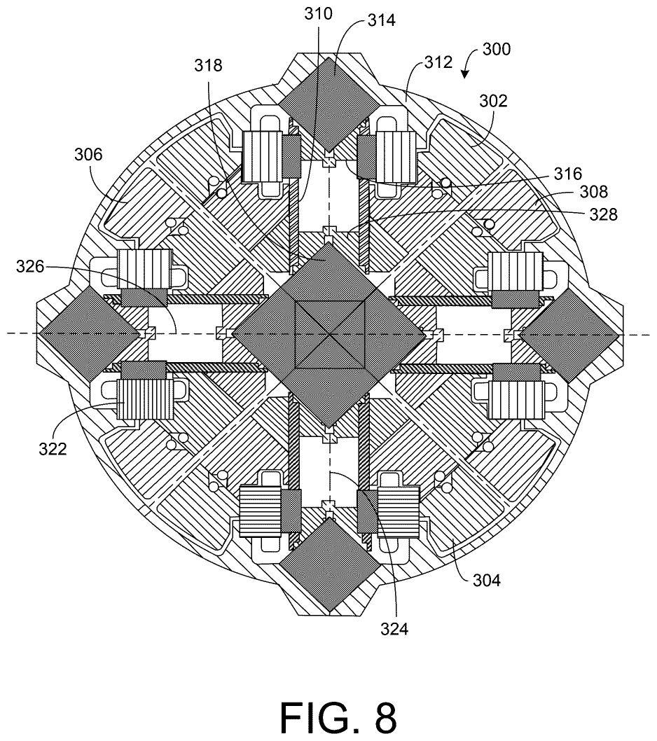

FIG. 8 shows the mechanical energy accumulator system 300 in accordance with the preferred embodiment of the present invention. FIG. 3 shows, in particular, a first pair of flywheels 302 and 304 and a second pair of flywheels 306 and 308. Flywheel 302 is a conical flywheel having a construction similar to that described in association with FIG. 7. Flywheel 302 is mounted to the shaft 310 within the interior of the housing 312. A first magnetic bearing 314 is affixed within the housing 312 so as to have a portion extending into the interior of the housing 312. A first counter-magnetic bearing 316 is affixed within one end of the shaft 310. The first magnetic bearing 314 has a conical portion that fits within a conical indentation of the first counter-magnetic bearing 316.

A second magnetic bearing 318 is affixed centrally of the housing 312. A second counter-magnetic bearing 320 is affixed in an opposite end of the shaft 310. The second magnetic bearing 318 includes a conical portion that is received within a conical indentation of the second counter-magnetic bearing 320. This configuration is repeated for each of the other flywheels 304, 306 and 308. Each of the flywheels 302, 304, 306 and 308 also includes a motor/generator 322 suitable for passing or delivering power to or from the mechanical energy accumulator system 300.

In FIG. 8, it can be seen that flywheels 302 and 304 are rotatable about a first axis 324. Similarly, the flywheels 306 and 308 are rotatable about a second axis 326. Flywheel 302 rotates in an opposite direction to that of the rotation of the flywheel 304. Flywheel 306 rotates in an opposite direction to that of the flywheel 308. The axis 324 is orthogonal to the axis 326.

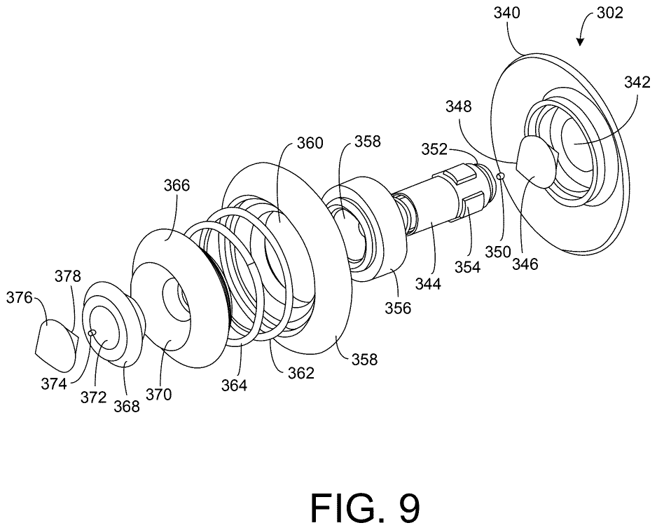

FIG. 9 shows the construction of the flywheel configuration of the mechanical energy accumulator system 300 of the present invention. In FIG. 9, it can be seen that the flywheel 302 includes a flywheel lid 340. Flywheel lid 340 has a conical shape. An opening 342 is shown centrally of the conical shape of the flywheel lid 340. An interior surface 342 is provided centrally of the conical shape of the flywheel lid 340. This area 342 is adapted to receive a surface of the first counter-magnetic bearing 346 therein. The first counter-magnetic bearing 346 also has a conical shape facing the interior area 342 and a conical shape facing away from this interior area 342. The conical shape of the first counter-magnet bearing 346 has a tip 348 that faces toward the interior of the housing 312. The shaft 344 will have a first counter-magnetic bearing 352 that faces the first magnetic bearing 346. Jewel 350 will fit within the recess of the conical indentation of the first counter-magnetic bearing 352. The repulsive forces of the first magnetic bearing 346 and the first counter-magnetic bearing 352 will assure that the shaft 344 rotates in a friction-free manner. Magnet 354 of the motor/generator 322 is shown as mounted on the exterior surface of the shaft 344. The motor stator 356 will have an interior 358 that extends around the shaft 344 and around the magnets 354. As such, the rotation of the magnets 354 with respect to the stator 356 will create a magnetic field for the generation of energy.

Another lid 358 of the flywheel 302 has an interior 360 that fits over the stator 356 and can be joined with the lid 340 of the flywheel 302. The lid 358 is also of a conical shape. Hoops 362 and 364 are arranged so as to be positioned in the interior of the lid 358. Hoops 362 and 364 are configured to be half-full of a liquid. Another section 366 of the flywheel 302 is joined to the lid 358 so as to sandwich the hoops 362 and 364 therebetween. A second counter-magnetic bearing 368 fits within the opening 370 of the flywheel section 366. The second counter-magnetic bearing 368 will also have a conical indentation 372. Jewel 374 will fit within the bottom of the conical indentation 372 of the flywheel section 368. A second magnetic bearing 376 includes a conical surface 378 that has a tip that will be in proximity to the jewel 374. Conical surface 378 will exert repulsive magnetic forces to that of the second counter-magnetic bearing 368 so as to assure the friction-free rotation of the flywheel 302.

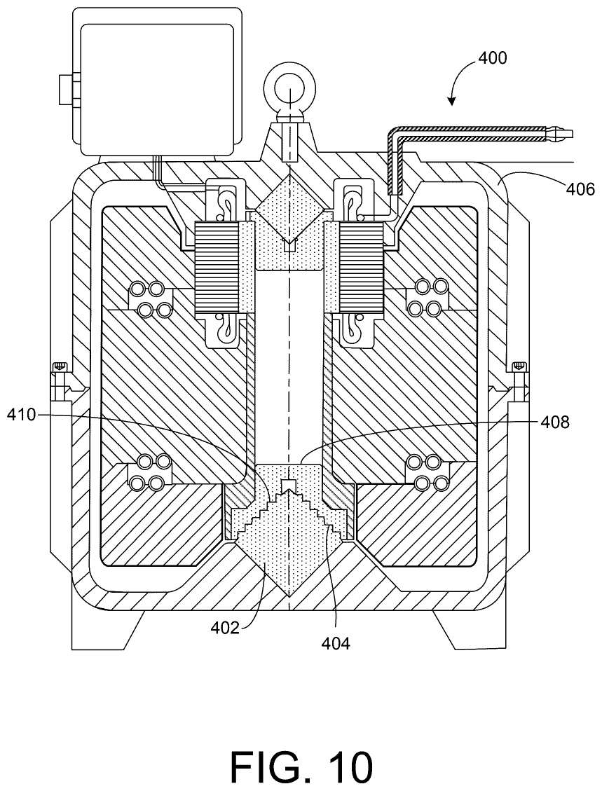

FIG. 10 shows an alternative embodiment of the present invention. In FIG. 10, the mechanical energy accumulator system 400 has a configuration similar to that of the previous embodiments, but includes a unique form of the magnetic bearings. In particular, the magnetic bearing 402 has a stepped surface 404 in the interior of the housing 406 of the mechanical energy accumulator system 400. Similarly, the counter-magnetic bearing 408 also has a stepped configuration 410 in the conical indentation thereof. The stepped surface 404 of the magnetic bearing 402 and the stepped indentation 410 of the counter-magnetic bearing 408 maximizes the magnetic surface area between the magnetic bearing 402 and the counter-magnetic bearing 408. As such, greater repulsive forces are able to be achieved between the surfaces thereof.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

1. A mechanical energy accumulator system comprising:
a housing;
at least a pair of conical flywheels rotatable about a first axis within said housing;
a shaft affixed to an interior of each of said at least a pair of conical flywheels, said shaft being rotatable so as to rotate the flywheel;
a first magnetic bearing affixed to said housing so as to face in interior of said housing; and
a first counter-magnetic bearing affixed to one end of said shaft, said first counter-magnetic bearing facing and adjacent to said first magnetic bearing such that magnetic forces in said first magnetic bearing and in said first counter-magnetic bearing cause the first magnetic bearing and said first counter-magnetic bearing to be slightly spaced from each other in generally friction-free relationship.

2. The mechanical energy accumulator system of claim 1, further comprising:
a second magnetic bearing positioned generally centrally of an interior of said housing; and
a second counter-magnetic bearing affixed to an opposite end of said shaft, said second magnetic bearing and said second counter-magnetic bearing facing each other such that magnetic forces in said second magnetic bearing and in said second counter-magnetic bearing cause said second magnetic bearing and said second counter-magnetic bearing to be slightly spaced from each other in a generally friction-free relationship.

3. The mechanical energy accumulator system of claim 2, said first magnetic bearing having a generally conical shape, said first counter-magnetic bearing having a conical indentation configured to overlie the generally conical shape of said first magnetic bearing.

4. The mechanical energy accumulator system of claim 3, said second magnetic bearing having a generally conical shape, said second counter-magnetic bearing having a conical indentation overlying the generally conical shape of said second magnetic bearing.

5. The mechanical energy accumulator system of claim 1, wherein said first magnetic bearing is a double cone magnet, at least a portion of the double cone magnet extending into the interior of said housing.

6. The mechanical energy accumulator system of claim 2, said second magnetic bearing being a double cone magnet, at least a portion of the double cone magnet of said second magnetic bearing being in an interior of said housing.

7. The mechanical energy accumulator system of claim 1, further comprising:
a motor/generator connected to each of said at least a pair of conical flywheels, said motor/generator adapted to store or produce energy in relation to a rotation of the flywheel.

8. The mechanical energy accumulator reader system of claim 7, further comprising:
a cooling fluid line extending into said housing so as to pass a cooling fluid to said motor/generator.

9. The mechanical energy accumulator system of claim 7, wherein said motor/generator has one of a stator and a winding affixed to the flywheel and another of the stator and the winding affixed to said housing.

10. The mechanical energy accumulator system of claim 7, said motor/generator having a power line extending outwardly of said housing and adapted to pass electrical energy to a location remote of said housing.

11. The mechanical energy accumulator system of claim 1, wherein each of said at least a pair of conical flywheels has a plurality of sections that are affixed together by a glue.

12. The mechanical energy accumulator system of claim 1, wherein each of said at least a pair of conical flywheels has a hoop affixed thereto, the hoop containing a liquid.

13. The mechanical energy accumulator system of claim 12, the hoop having an interior volume, the interior volume of the hoop being approximately one-half filled with the liquid.

14. The mechanical energy accumulator system of claim 12, wherein each of said at least a pair of conical flywheels is formed of a plurality of sections, the hoop being positioned between adjacent sections of the plurality of sections.

15. The mechanical energy accumulator system of claim 1, wherein each flywheel of said at least a pair of conical flywheels has an outer covering.

16. The mechanical energy accumulator system of claim 15, wherein the outer covering is of a composite material.

17. The mechanical energy accumulator system of claim 3, wherein at least one of the generally conical shape of said first magnetic bearing and the conical indentation of said first counter-magnetic bearing has a stepped configuration.

18. The mechanical energy accumulator system of claim 3, further comprising:
a jewel interposed between a tip of the generally conical shape of said first magnetic bearing and interior of the conical indentation of said second counter-magnetic bearing.

19. The mechanical energy accumulator system of claim 1, wherein said at least a pair of conical flywheels comprises six flywheels arranged within said housing, the six flywheels, comprising:
a first pair of flywheels arranged so as to be rotatable in opposite directions about a first axis;
a second pair of flywheels arranged so as to be rotatable in opposite directions about a second axis; and
a third pair of flywheels arranged so as to be rotatable in opposite directions about third axis, the first axis and the second axis and the third axis being orthogonal to each other.

20. The mechanical energy accumulator system of claim 1, wherein said housing has a generally spherical configuration.
